(19) United States
(12) Patent Application Publication
(10) Pub. No.: US 2026/0335987 A1
(43) Pub. Date: Oct. 29, 2026

(54) Adjustable Depth Setting Collar

(71) Applicant: Starborn Industries, Inc., Edison, NJ (US)

(72) Inventors: Paul Gertner, Edison, NJ (US); Steven Checco, Edison, NJ (US)

(21) Appl. No.: 19/661,211

(22) Filed: Apr. 28, 2026

Related U.S. Application Data
(60) Provisional application No. 63/795,771, filed on Apr. 28, 2025.

(51) Int. Cl. B23B 49/00

(52) U.S. Cl. CPC B23B 49/005; B23B 2260/0482

(57) ABSTRACT

Disclosed is an adjustable depth setting device and method capable of withstanding the increased forces and vibration of high-performance drills and impact drivers while maintaining accurate, consistent fastener depth without loosening. The device includes a mating central collar and an adjustable cap. The central collar is fitted onto a tool, which may be a drill, a conventional depth setting tool, or another suitable tool, and may alternatively be integral with the tool. The adjustable cap is interlocked with the central collar. Protrusions and corresponding slots may be formed on the adjustable cap, the central collar, or both. Depth adjustment is achieved by rotating the cap so that the protrusions engage slots of different heights on the collar. The protrusions may be perpendicular or angled to provide a ratcheting function. The collar may further include an outward lip to provide additional contact and enhanced interlocking with the adjustable cap.

### CROSS-REFERENCE TO RELATED APPLICATIONS

This application is a U.S. Non-provisional Patent Application under 35 U.S.C. § 111(a) that claims the benefit to U.S. Provisional Patent Application No. 63/795,771 having a filing date of Apr. 28, 2025, the disclosure of which is hereby incorporated herein by reference.

### TECHNICAL FIELD

The present disclosure relates to an apparatus used to adjustably set a depth of a fastener inserted by a drill. Specifically, the disclosure related to an adjustable depth setting collar that allows a drill to vary its drilling depth without the need to change drill bits or other tools.

### BACKGROUND OF THE INVENTION

Drill bits have been used for thousands of years, for various purposes such as creating fire, woodworking, and masonry applications. The earliest evidence of drill bits dates back to ancient times, where a sharpened stick was used to make holes in soft materials. During ancient times, drill bits were made of flint, bone, or bronze. The modern drill bit, which is made of high-speed steel or carbide, was patented in the late 19th century and became widely used in the 20th century for drilling into hard materials such as metal or stone. Today, drill bits come in various sizes and are used in many industries including construction, mining, and manufacturing to name a few applications. Carbide-tipped drill bits were invented in the mid-20th century, and the use of carbide in cutting tools can be traced back to the 1920s and 1930s. The innovation of carbide-tipped drill bits revolutionized drilling by providing a more durable and efficient alternative to traditional high-speed steel bits. The increased hardness and abrasion resistance of carbide allowed for faster and more accurate drilling, particularly in hard materials.

Drills and drill bits not only are used to produce a hole in a material but are also used in insertion of fasteners into materials. The use of screw type drill bits to insert fasteners are used in drywalling, carpentry, framing, securing cladding material on the facades of buildings, decking applications, and the like. The concept of adjustable depth for drilling likely emerged as a need for precise fastener placement and consistent depth. This was achieved initially through simple methods like marking depth with tape or using drill guides. However consistent drill depth was unachievable using these techniques.

Early depth setting devices have been well known on the market for at least the past 30 years. These bits or tools attach to the working end of a power tool such as an impact driver or a drill and set fasteners at a specific desired depth. Some depth setting devices on the market feature an adjustable function which typically uses a threaded collar which travels up and down a threaded portion on the main shaft of the device.

Recently, drill and impact driver manufacturers have made a consistent effort to increase the speed, torque strength and overall power of their tools. Consequently, this increase in power and performance also led to an increase in both the forces and vibration that depth setting devices are subjected thereto. These heavy vibrations and forces can often cause the adjustable feature on current depth setting devices to loosen, eliminating the accuracy of the installation.

Current attempts to overcome these deficiencies has had limited success. For example in International Patent Publication WO2024/254617 titled “Depth Setting Bit Drivers, Systems and Related Methods, to White et. al. discloses a depth setting bit driver. The depth setting bit driver includes a depth adjustment member threadedly coupled with a drive sleeve such that a first depth adjustment member is threadedly longitudinally movable along the drive sleeve to adjust the longitudinal position of a stop portion, thereby adjusting the depth of a fastener. Because the stop portion mechanism is also threaded, high rotation or torque of a power tool may incidentally loosen the position and result in inconsistent depth settings of the fasteners.

US Patent Publication US 2020/0306839A1 titled “Depth Adjustment Stopper for Drill Bit,” to Lee discloses a depth adjustment stopper for a drill bit. The stopper gives a fixed depth into a material by means of a drill bit. The depth adjustment stopper coupled to the drill bit is supported by means of the tension of a spring. Therefore, the depth adjustment stopper is prevented from shaking or being pushed. However, this device lacks the ease of adjustability from depth to depth. In addition, the device is prone to loosen thus inconsistent fastener depths as the spring mechanism that supports the stopper is prone to high torque and forces from more powerful newer drills.

U.S. Pat. No. 7,258,513 B2 titled “Depth Limiting Device and Hole Forming Apparatus Containing the Same,” to Gertner discloses a depth limiting device that includes a stop collar at a predetermined length and a spindle for isolating rotation of the spindle from the stop collar whereby the stop collar ceases to rotate when contacting a workpiece. While this invention is to reduce frictional contact to mar or otherwise damage a work piece, it lacks the ease in adjustability of depth without removal of the depth limiting device from the drill as well as lacking provision to provide for a screw type bit assembly for use with fasteners.

Therefore, there is still a need in the art for improved means to adjust the depth of fasteners that could provide precise depth control for consistent and reliable results in view of today's high speed and powered drilling tools.

### SUMMARY

Compared to the above prior attempts, the present disclosure fulfills the above criteria and provides additional benefits that state-of-the-art systems cannot provide. Unlike the above prior methods and devices, the present methods and devices ensure reliable and consistent insertion of fasteners at a selected depth. The device allows for an adjustable depth setting that can withstand the stronger forces and vibration of today's higher performance drills and impact drivers, all the while maintaining an accurate and consistent fastener depth without loosening. The device includes an adjustable cap and a central collar. The adjustable cap may or may not include a mar resistant layer disposed on its top to reduce markings on the material being worked upon.

The present innovation can surpass the current standard by consistently achieving the desired depth despite high torque forces. The device is designed to be utilized with current state of the art depth setters for a power drill, or attached to a drill bit or other tool, or can be used as a stand-alone device attached to a drill.

The present methods and devices allow an adjustable depth setting collar device for use with a rotating tool shaft. The device includes a central collar and an adjustable cap. The central collar is friction fitted onto the shaft of the tool. Again the tool may be the drill itself, any type of drill bit, a drill bit that includes the central collar, wherein the central collar may be fixedly attached or removably attached to the drill bit, or even wherein the central collar is an integral part of the drill bit. The tool may also be a conventional depth setting device or other attachment to the drill. The drill may be any type of power drill or any other device used to put fasteners in material or make holes in a material. The central collar may include a plurality of cantilevered steps arranged at incrementally different heights around the collar. The heights may differ in 1 mm increments or various other increments either consistent increments or in various depth increments. A plurality of steps form a plurality of slots on the central collar. The plurality of slots are oriented either perpendicularly or at an angle for providing a ratchet function.

The adjustable cap is configured to friction fit onto the central collar, and may include a plurality of protrusions extending from one end of the cap at incrementally different heights and arranged to interlock with the slots of the collar. Interlocking engagement occurs between the protrusions of the cap and the slots of the central collar that prevents rotational movement of the cap relative to the collar during operation of the tool. Depth adjustment is achieved by rotating the cap to position the protrusions into different slots on the collar.

In another aspect, the collar may also include a lip. The lip may be used for additional interlocking security when protrusions of the adjustable cap sit in the slots of collar underneath the lip. This arrangement provides for additional contact.

In yet another aspect, the adjustable depth setting device and methods of using the device to control the depth of fastener insertion includes using a rotating power tool. In one aspect, the method in which an adjustable depth setting collar is provided has a central collar and an adjustable cap. The central collar includes a plurality of slots arranged at incrementally different axial heights, and the adjustable cap includes a plurality of protrusions arranged to selectively interlock with the slots.

In use, the central collar is disposed on a shaft of a rotating power tool such that the central collar is fixed against rotation relative to the shaft during operation. A desired depth setting is selected by moving the adjustable cap between a disengaged condition that permits relative rotation of the cap with respect to the central collar, and an engaged condition in which one or more protrusions are received within selected slots corresponding to the desired depth setting. The cap may be axially displaced to permit rotation and then re-seated to effect engagement.

The method further includes operating the power tool to drive a fastener into a workpiece, with further insertion limited by contact between the adjustable cap and the workpiece while the cap remains interlocked with the central collar, thereby maintaining the selected depth setting during use.

The present innovative design addresses problems of the current state-of-the-art power tools that have additional torque and cause slippage of conventional depth setting tools. This innovative device is further explained here in the detailed description and accompanying figures.

### BRIEF DESCRIPTION OF THE DRAWINGS

To assist those of skill in the art in making and using the disclosed composition and method, reference is made to the accompanying figures, wherein:

FIGS. 1A-1C are photographs that show various versions of the adjustable depth setting collar; FIG. 1A shows a conventional depth setter and various versions of the present adjustable depth setting collar with one of the versions attached to the conventional depth setter; FIG. 1B shows one of the versions attached to the conventional depth setter with the cap removed; FIG. 1C shows a side view of FIG. 1B.

FIGS. 2A-2D are photographs of the adjustable depth setting collars shown in FIGS. 1A-1C in an isometric view; FIG. 2A shows the collar disassembled having a cap and central collar; FIG. 2B shows the central collar with a lip and the cap with additional protrusions inside the cap; FIG. 2C shows the collar frictionally fitted over a conventional depth setting tool; and FIG. 2D shows a disassembled adjustable setting collar with additional protrusions on the outside of the cap.

FIGS. 3A-3D illustrate the function of the adjustable depth setting collar; FIG. 3A shows the cap and the central collar in the engaged locked setting; FIG. 3B shows the adjustable depth setting collar in the disengaged setting allowing the cap to rotate about the central collar to a particular setting; FIG. 3C shows a front view of the collar inserted over a conventional depth setting tool with the cap removed; FIG. 3D shows an isometric view of FIG. 3C.

FIGS. 4A-4E are illustrations showing one embodiment of the adjustable depth setting collar; FIG. 4A is a front view showing the cap and central collar disassembled; FIG. 4B is a back view of FIG. 4A; FIG. 4C is an isometric top view of FIG. 4A; FIG. 4D is an isometric bottom view of FIG. 4A; and FIG. 4E illustrates a three dimensional view of the cap and central collar of FIG. 4A.

FIGS. 5A-5E illustrate one embodiment of the adjustable depth collar having angular protrusions in the cap in a direction outward from the cap and matching slots in the central collar; FIG. 5A shows an isometric bottom view with the central collar on top and the cap on the bottom; FIG. 5B shows an isometric top view of FIG. 5A; FIG. 5C shows a front view of FIG. 5A, FIG. 5D shows a back view of FIG. 5A, and FIG. 5E shows an isometric view of FIG. 5A

FIGS. 6A-6E illustrates one embodiment of the adjustable depth collar having angular protrusions in the cap in a direction circularly about the cap and matching slots in the central collar; FIG. 6A shows a front view of the cap and central collar disassembled; FIG. 6B shows a back view of FIG. 6A; FIG. 6C shows an isometric bottom view of FIG. 6A, and FIG. 6D shows an isometric top view of FIG. 6A, and FIG. 6E shows an isometric view of FIG. 6A.

FIG. 7 illustrates the central collar and cap having linear slots and linear protrusion, respectively.

FIG. 8 illustrates the central collar having a lip and frictionally attached to a conventional tool.

FIG. 9 illustrates a side view of the central collar and cap in FIG. 8.

FIG. 10 illustrates the central collar having a lip and two sets of slots with the cap having two sets of protrusions with one set of protrusions inside the cap for both sets of protrusions engaging the central collar.

FIGS. 11A-11C illustrate the central collar being either integral or removably or fixedly attached to a tool; FIG. 11A is a front view of the central collar and tool; FIG. 11B is an isometric top view of FIG. 11A; and FIG. 11C is an isometric bottom view of FIG. 11A.

### DETAILED DESCRIPTION

The present design, among other things, enables and combines a device with an adjustable depth setting collar. The adjustable depth setting collar includes two main portions: a central collar and adjustable cap. The central collar, depending on the implementation, is preferably sized as a hollow cylinder to provide a friction fit onto a shaft of the tool. The tool may be a portion of a power drill, an axillary portion added to a power drill, a conventional depth setting tool that may or may not be attached to a power drill, and any combination thereof. The central collar has at least one series of cantilevered teeth at incrementally different heights surrounding the cap to produce different slots for the adjustable cap. Depending on the embodiment, the difference in heights may differ in about 1 mm increments or other increments to fit standardized depth setting of fasteners. In some embodiments two series of cantilever teeth may be utilized to produce more engagement between the central collar and the cap.

Depending on the embodiment, the teeth may be square cornered, triangular, chamfered, or wedge shaped and can function either by pulling down and pushing back up or where the shape is permitted by rotation similar to that of a ratchet or a ratchet function. The collar may also have an additional lip outside of the steps for additional contact with the interlocking cap.

The second portion of the adjustable depth setting collar is an adjustable cap. The adjustable cap is friction fit onto the central collar and has at least one series of teeth protruding from one end at incrementally different heights around the cap. Such teeth may be square cornered, triangular, chamfered, or wedge shaped and can function either by pulling down and pushing back up the cap. Where the shape is permitted the cap, such as but not limited to having a design with angular teeth angled in an axis circumferentially around the collar and cap, may be rotated about the fixed central collar by rotation similar to that of a ratchet. These teeth are received into the slots of the collar, interlocking the two components-central collar and cap.

This interlocking between the cap and the collar prevents the cap from moving as the drill or impact driver rotates and vibrates during installation. To adjust the depth the cap can be rotated so that the teeth of the collar sit in the teeth of different heights on the collar. When the collar has a lip, the teeth of the cap sit in the teeth of the collar underneath the lip for added contact. A second set of protrusions and slots may be provided on the cap and central collar respectively to provide additional engagement and security to further provide consistent depth of a fastener being inserted by a power drill.

The material for the central collar and cap is a material suited for low friction and wear resistance. The cap and central collar may be made of the same material or different materials depending on the application. The materials include, but are not limited to, polymer materials, ceramic, metal, stainless steel, copper, brass, and any combination thereof. The polymer material may be combined with other polymer materials or metals such that the low friction and wear resistance material is the protrusion, teeth, and slot portions only. For applications requiring low friction and wear resistance, nylon, polycarbonate, polyacrylate, polypropylene, polyethylene, high or ultra-high molecular weight (UHMW) polyethene, and polytetrafluoroethylene (Teflon), or other self-lubricating polymers that has a low coefficient of friction.

Connection between the tool and the central collar may be accomplished in many different ways. For example, connection includes, but is not limited to, a mechanical fit that includes snap fits (cantilever, torsional, annular), threaded joints, press fits, bosses, and any combination thereof. The connection between the tool and the central collar may either be removably fixed-meaning the central collar is secure on the tool while in use and once use is completed may be removed-or fixedly attached-meaning once assembled it cannot be removed. In the alternative the central collar and the tool may be an integral single piece. These and other embodiments are further discussed herein.

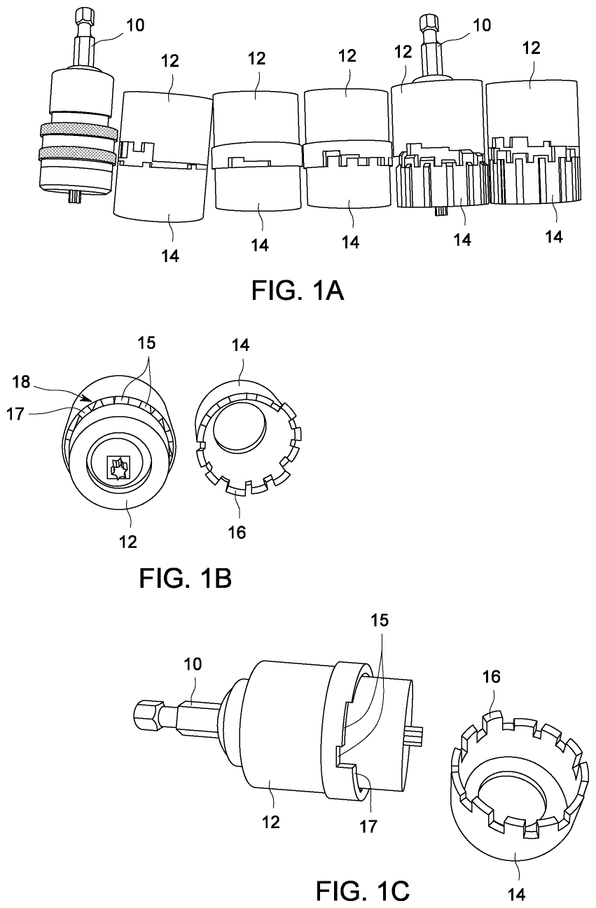

Adverting to the drawings, show in FIGS. 1A-1C are various versions of the adjustable depth setting collar comprising central collar 12 and adjustable cap 14. FIG. 1A shows a conventional depth setter 10 and various versions of the present adjustable depth setting collar with one of the versions attached to the conventional depth setter. FIG. 1B shows one of the versions attached to the conventional depth setter with the cap removed. In one embodiment, cap 14 contain protrusions 16 extending outwardly from the bottom of the cap. FIG. 1C shows a side view of FIG. 1B. The central collar 12 may contain a lip 18 and teeth or cantilever steps 17 forming slots 15 on the central collar. The lip 18 may or may not be used on the central collar. If the lip 18 is used the protrusions travel below the lip providing additional security and engagement between the central collar and cap. With or without the lip on the cap, the protrusions engage with the slots to provide secure engagement between the cap and central collar.

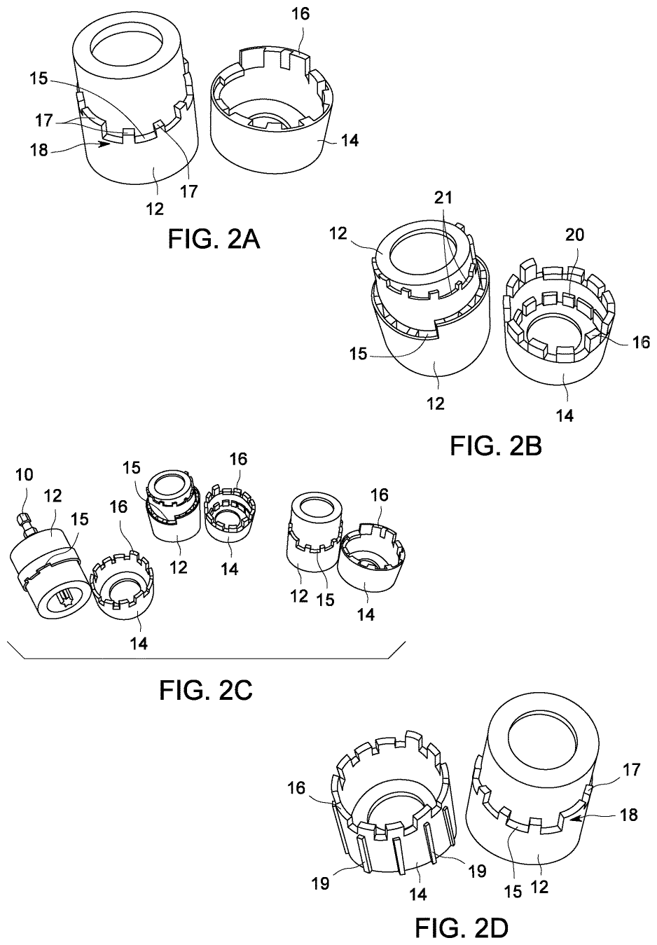

FIGS. 2A-2D are photographs of the adjustable depth setting collars shown in FIGS. 1A-1C in an isometric view to illustrate certain features. FIG. 2A shows the collar disassembled having a cap and central collar. In this embodiment one set of slots on the collar and one set of matching protrusions are shown. In FIG. 2B shows the central collar with the lip and the cap with additional protrusions 20 inside the cap. These inside additional protrusions engage with additional slots 21 on the central collar as shown. FIG. 2C shows the central collar 12 frictionally fitted over a conventional depth setter tool 10. The central collar is unable to rotate and is fixedly removable on the tool. Again the tool may be a multiple of different items that contain a shaft for the central collar to friction fit upon. FIG. 2D shows a disassembled adjustable setting collar with additional protrusions 19 on the outside of the cap. Outside cap protrusions 19 may be ribs or similar designs utilized for hand gripping the cap for ease of use.

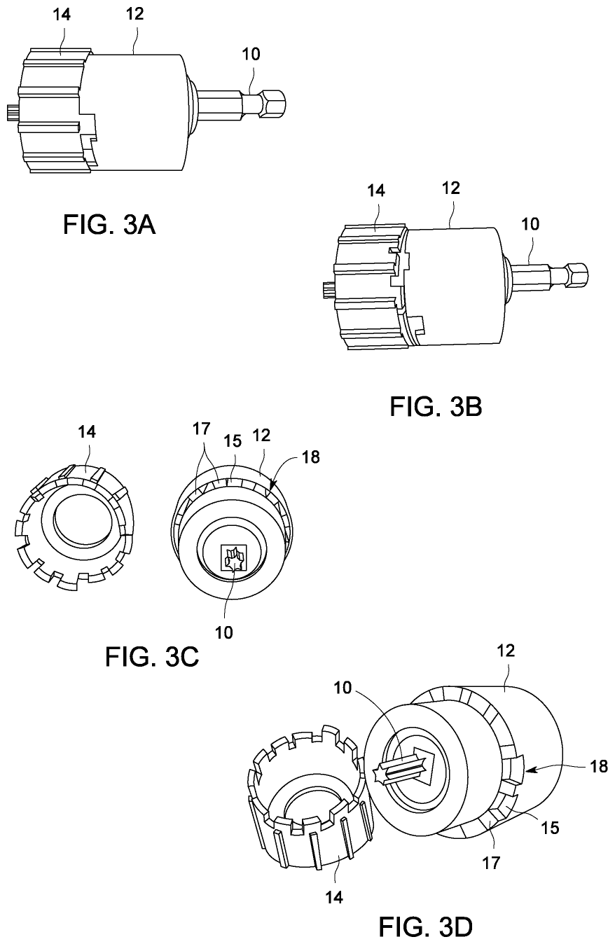

FIGS. 3A-3D illustrate the function of the adjustable depth setting collar. FIG. 3A shows the cap and the central collar in the engaged locked setting. FIG. 3B shows the adjustable depth setting collar in the disengaged setting allowing the cap to rotate and/or be lifted about the central collar to a particular setting. FIG. 3C shows a front view of the collar inserted over the conventional depth setting tool with the cap removed. FIG. 3D shows an isometric view of FIG. 3C. To adjust the depth, a user pulls the cap distally away from the central collar and rotates the cap slightly before reinserting the cap onto the central collar. Each tooth or step is for a different height giving a different depth setting for the adjustable collar. The adjustable collar provides at least four (4) different heights in increments; however, the increments may be at least two different height increments. Typically these increments are 1 mm increments to provide depth differences accordingly. Depending on the embodiment it may be different increment sizes such as but not limited to one sixteenth inch increments ( 1/16″) or some other increment. In addition, the increments may have the same value or different values depending on the embodiment. For example, each step may be 1 mm difference and then 2 mm or higher difference between each steps.

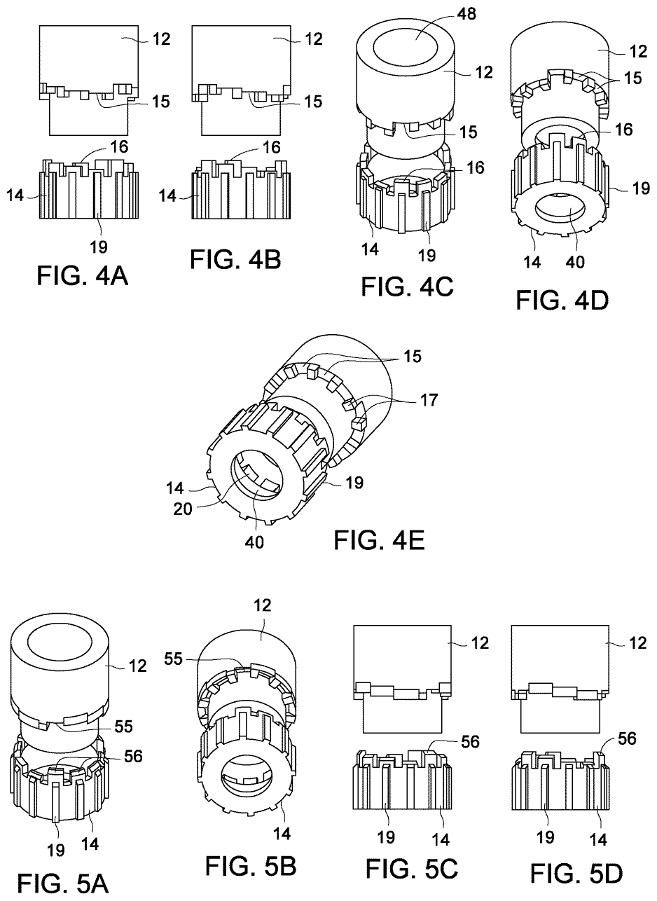

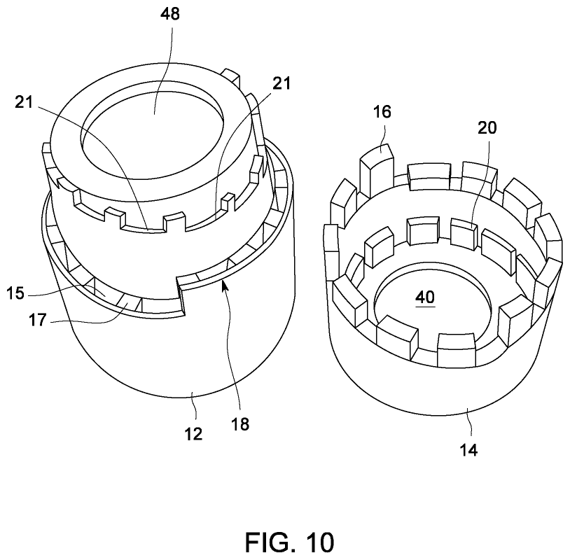

FIGS. 4A-4E are illustrations showing one embodiment of the adjustable depth setting collar. FIG. 4A is a front view showing the cap and central collar disassembled. The protrusions and matching slots are rectangular in this embodiment. FIG. 4B is a back view of FIG. 4A. showing the various height increments between the protrusions 16 and slots 15. FIG. 4C is an isometric top view of FIG. 4A showing hole 40 that is through the cap and in communication with hole 48 of the central collar as shown and also in FIG. 10. Both these holes allow access to the shaft of the tool. FIG. 4D is an isometric bottom view of FIG. 4A. FIG. 4E illustrates a three dimensional view of the cap and central collar of FIG. 4A. This design in these figures however instead of the lip, have the teeth on the collar thicker than the teeth on the cap to prevent slip during installation. This cap also has some ridges or protrusions 19 added so the user can get a better grip on the cap when adjusting the depth.

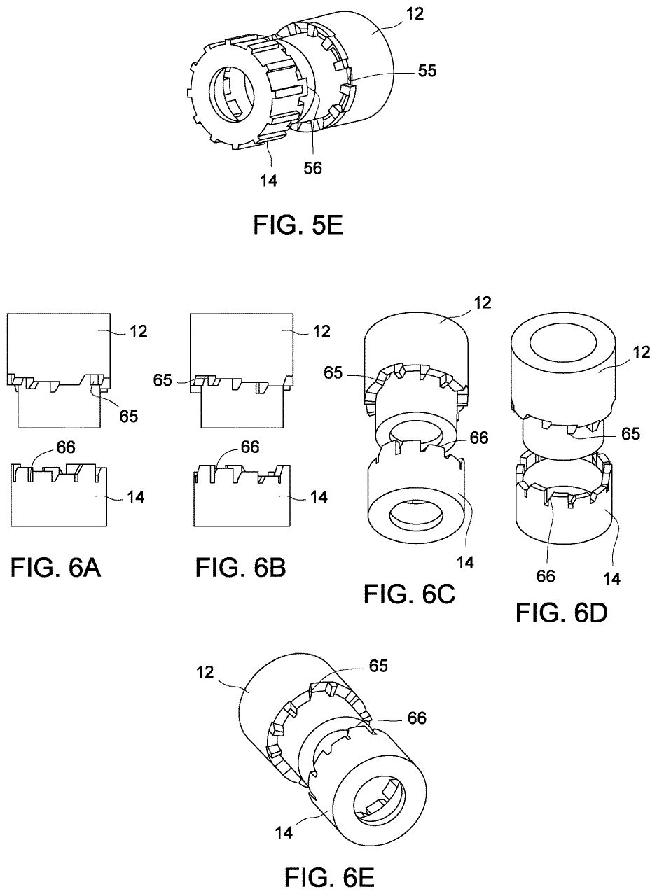

FIGS. 5A-5E illustrate one embodiment of the adjustable depth collar having angular protrusions 56 in the cap in a direction outward from the cap and matching slots in the central collar. These angular protrusions may be in the shape of a beveled edge corner, wedge, or chamfer. Matching angular slots 55 may also contain similar designs as the cap. FIG. 5A shows an isometric bottom view with the central collar on top and the cap on the bottom illustrating the angular protrusions and matching angular slots. FIG. 5B shows an isometric top view of FIG. 5A further illustrating these angular features. FIG. 5C shows a front view of FIG. 5A, and FIG. 5D shows a back view of FIG. 5A, wherein the beveled protrusions are shown, as well as in FIG. 5E that shows an isometric view of FIG. 5A. This design provides for each of the teeth on both the central collar and the cap to be chamfered at contradictory 45 degree angles to make the cap easier to interlock and to further prevent slip during installation. Other angular degrees are possible; however, it was found that the 45 degree chamfered angle provided better use than other degrees of the angle.

FIGS. 6A-6E illustrates one embodiment of the adjustable depth collar having angular protrusions 66 in the cap in a direction circularly or circumferentially about the cap and matching angular slots 65 in the central collar. In contrast to the chamfered angled protrusions that are angled outwardly from the cap as shown in FIGS. 5A-5E, these protrusions are not angled outwardly but in the same circular axis as the cap. FIG. 6A shows a front view of the cap and central collar disassembled. FIG. 6B shows a back and FIG. 6C shows an isometric bottom view of FIG. 6A. FIG. 6D shows an isometric top view of FIG. 6A, and FIG. 6E shows an overall isometric view of FIG. 6A.

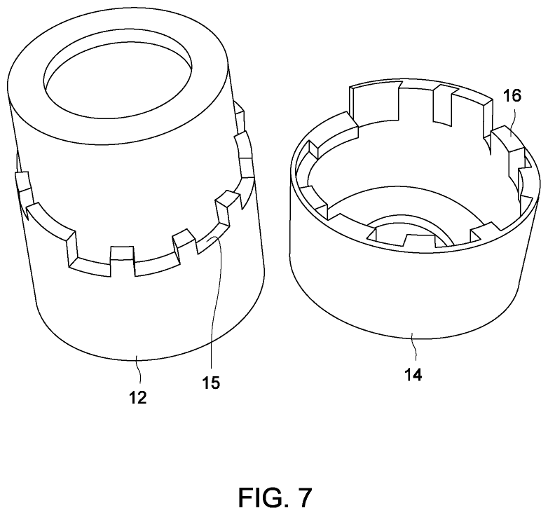

FIG. 7 illustrates the central collar and cap having linear slots and linear protrusion, respectively. Again, the central collar friction fits onto a conventional depth setter or shaft of a tool of a power drill. The cap then friction fits onto the central collar:

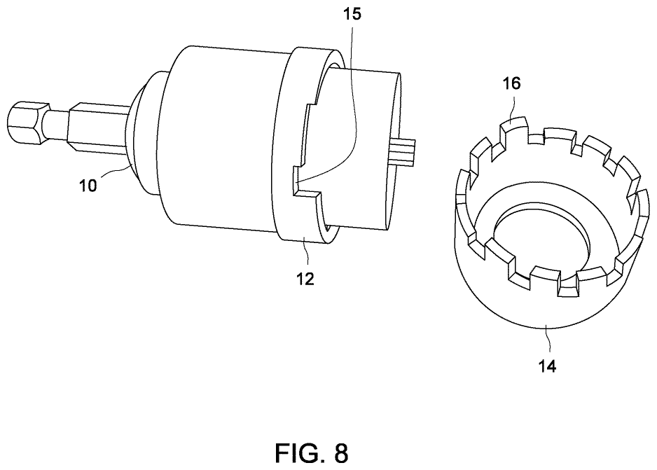

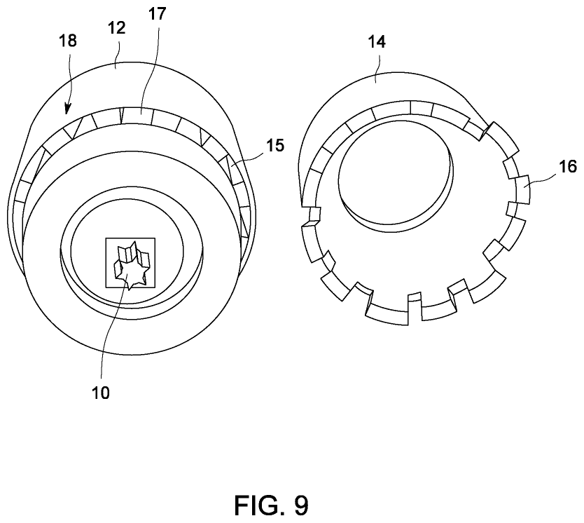

FIG. 8 illustrates the central collar having a lip and frictionally attached to a conventional tool. FIG. 9 illustrates a side view of the central collar and cap in FIG. 8. This design has more teeth and a lip around the collar to prevent the teeth on the cap from slipping out during installation.

FIG. 10 illustrates the central collar having a lip and two sets of slots with the cap having two sets of protrusions, having protrusions 16 and additional protrusions 20, with one set of protrusions, namely protrusions 20, inside the cap, wherein both sets of protrusions engage the central collar. The central collar has a plurality of slots 15 that fixedly engage with protrusions 16. In addition the central collar has additional slots 21 that fixedly engage with protrusions 20. This arrangement provided additional security and significantly reduced any slippage that could negatively affect consist of depth setting, especially in the insertion of fasteners at a specific depth in a material and for added stability when using high powered drills.

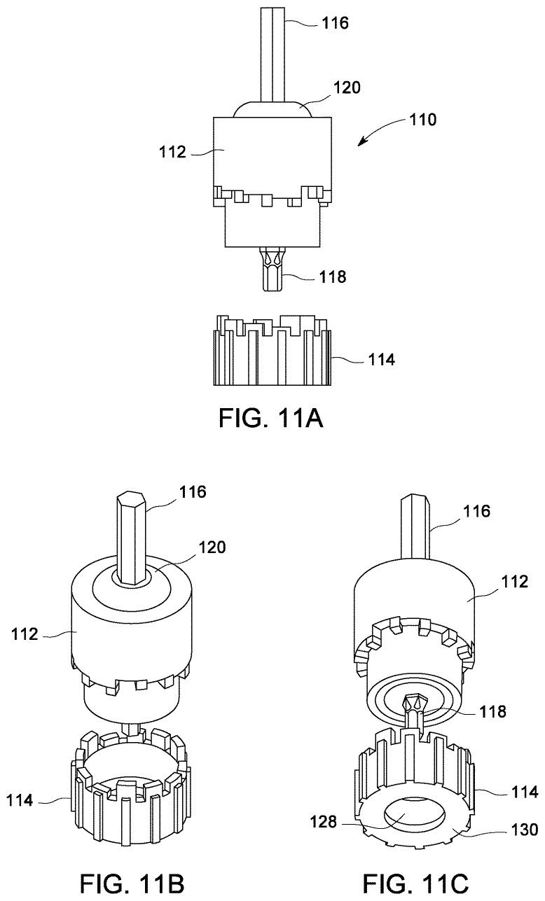

FIGS. 11A-11C illustrate the central collar being either integral or removably or fixedly attached to a tool. Shown in FIG. 11A is a front view of an adjustable depth setting device 110 having a central collar 112, tool 120 and an adjustable cap 114. The tool 120 further includes a stem 116 that attaches to the drill and a screw feature 118 for inserting fasteners into a material. The screw feature may also be a drill depending on the implementation. FIG. 11B is an isometric top view of FIG. 11A; and FIG. 11C is an isometric bottom view of FIG. 11A. Shown in this view is hole 128 of the adjustable cap 114 where the screw feature 118 passes therethrough when the adjustable cap is attached to the central collar for use. Also shown on FIG. 11C is mar surface 130. The mar surface may be provided on the cap to reduce marking the material when the adjustable depth setting device is used. The mar surface may include, but is not limited to, a polymer coating, nano silica coating, ceramic coating, layer material made of a scar or scratch resistance material, polytetrafluroethylene (PTFE-Teflon), and the like. Again, depending on the implementation the central collar may be integral with the tool, or attached to the tool, for example either mechanically or through a fiction fit or other connections previously described herein. Furthermore any of the teeth and slot configurations previously described may be used in this embodiment including any of the features of the adjustable cap and central collar.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

Any headings and sub-headings utilized in this description are not meant to limit the embodiments described thereunder. Features of various embodiments described herein may be utilized with other embodiments even if not described under a specific heading for that embodiment.

In addition, it is expressly noted that these embodiments should not be construed as limiting, but rather that additions and modifications to what is expressly described herein also are included within the scope of the invention. Moreover, it is to be understood that the features of the various embodiments described herein are not mutually exclusive and can exist in various combinations and permutations, even if such combinations or permutations are not made express herein, without departing from the spirit and scope of the invention.

1. An adjustable depth setting device, comprising:
a central collar disposed onto a tool, the central collar including a plurality of cantilevered steps arranged at incrementally different heights around the collar; the plurality of steps forming a plurality of slots; wherein the plurality of slots are oriented either perpendicularly or at an angle for providing a ratchet function;
an adjustable cap configured to fit onto the central collar, and includes a plurality of protrusions extending from one end of the cap at incrementally different heights and arranged to interlock with the slots of the collar; and
wherein interlocking engagement between the protrusions of the cap and the slot of the central collar prevents rotational movement of the cap relative to the collar during operation of the tool, and wherein depth adjustment is achieved by rotating the cap to position the protrusions into different slots on the collar.

2. The adjustable depth setting device of claim 1, wherein the cantilevered steps form a radially outer ring on the collar, and the plurality of slots are in a circular array of slots.

3. The adjustable depth setting device of claim 1, wherein the slots of the collar are at an angle relative to the collar's vertical axis to provide a unidirectional ratcheting mechanism.

4. The adjustable depth setting device of claim 1, wherein the collar further comprises an annular lip located radially outward of the cantilevered steps, and wherein the lip is configured to provide additional contact surface with the protrusions of the cap for enhanced interlocking.

5. The adjustable depth setting device of claim 4, wherein the protrusions on the cap are dimensioned to extend underneath the lip of the collar when engaged in the slots.

6. The adjustable depth setting device of claim 1, wherein the protrusions on the cap are angled and the slots of the collar are similarly angled to match angled orientation for providing a ratchet-like locking function; and wherein the protrusions on the cap differ in 1 mm increments.

7. The adjustable depth setting device of claim 1, wherein the central collar and the cap are both made of a polymeric material to facilitate repeated friction fitting and adjustment.

8. The adjustable depth setting device of claim 1, wherein the cap and collar are dimensioned to permit incremental depth settings by engaging the protrusions with slots of different heights.

9. The adjustable depth setting device of claim 1, wherein the tool shaft is part of a drill or impact driver, and the adjustable collar serves to control fastening or drilling depth.

10. The adjustable depth setting device of claim 1, further comprising an additional set of protrusions disposed about the adjustable cap for interlocking with the central collar.

11. The adjustable depth setting device of claim 1, wherein the central collar is configured to friction fit onto the tool.

12. The adjustable depth setting device of claim 11, wherein the tool further includes a shaft and the central collar is friction fitted onto the shaft.

13. The adjustable depth setting device of claim 1, wherein the central collar is attached to the tool by a mechanical attachment.

14. The adjustable depth setting device of claim 13, wherein the mechanical attachment includes a snap fit, cantilever, torsional snap fit, annular snap fit, threaded joint, press fit, bosses, and any combination thereof.

15. An adjustable depth setting device, comprising:
an adjustable depth setting device having a central collar and an adjustable cap; the central collar is disposed onto a tool or is an integral part of the tool, the central collar includes a plurality of cantilevered steps arranged at incrementally different heights around the collar; the plurality of steps forming a plurality of slots; wherein the plurality of slots are oriented either perpendicularly or at an angle for providing a ratchet function;
the adjustable cap configured to fit onto the central collar, and includes a plurality of protrusions extending from one end of the cap at incrementally different heights and arranged to interlock with the slots of the collar; and
wherein interlocking engagement between the protrusions of the cap and the slot of the central collar prevents rotational movement of the cap relative to the collar during operation of the tool, and wherein depth adjustment is achieved by rotating the cap to position the protrusions into different slots on the collar.

16. The adjustable depth setting device in claim 15, wherein the adjustable cap further includes a layer or a coating that provides mark or scratch resistance.

17. A method of using an adjustable depth setting device, comprising:
(a) providing an adjustable depth setting collar comprising (i) a central collar having a plurality of slots at incrementally different axial heights and (ii) an adjustable cap having a plurality of protrusions at incrementally different axial heights configured to selectively interlock with the plurality of slots;
(b) disposing the central collar on a shaft of a rotating power tool such that the central collar is fixed against rotation relative to the shaft during operation; and
(c) selecting a desired depth setting by moving the adjustable cap between (i) a disengaged condition permitting relative rotation between the adjustable cap and the central collar and (ii) an engaged condition in which at least one of the protrusions is received in a selected one of the slots corresponding to the desired depth setting.

18. The method of claim 17, wherein step (c) further comprises axially pulling the adjustable cap distally away from the central collar to the disengaged condition, rotating the adjustable cap relative to the central collar to align the protrusions with a different one of the slots, and axially re-seating the adjustable cap on the central collar to the engaged condition.

19. The method of claim 17, further comprises operating the rotating power tool to drive a fastener into a workpiece.

20. The method of claim 19, further comprises limiting further insertion of the fastener at the desired depth setting by contacting the workpiece with the adjustable cap while the protrusion remains interlocked with the selected slot to resist rotational movement of the adjustable cap relative to the central collar during the operating step.
